(19) United States
(12) Patent Application Publication
(10) Pub. No.: US 2025/0282286 A1
(43) Pub. Date: Sep. 11, 2025

(54) LIGHT LEAKAGE PREVENTION APPARATUS FOR VEHICLE AND MANUFACTURING METHOD THEREOF

(71) Applicant: HYUNDAI MOBIS CO., LTD., Seoul (KR)

(72) Inventor: Ju Ho HYUN, Daegu (KR)

(73) Assignee: HYUNDAI MOBIS CO., LTD., Seoul (KR)

(21) Appl. No.: 19/217,849

(22) Filed: May 23, 2025

(30) Foreign Application Priority Data
Sep. 4, 2023 (KR) 10-2023-0116923

(51) Int. Cl. B60Q 3/72; B60Q 3/60

(52) U.S. Cl. CPC B60Q 3/72; B60Q 3/60

(57) ABSTRACT

A light leakage prevention apparatus for a vehicle, and a method therefor are provided. The apparatus includes a printed circuit board (PCB) including two or more light sources, a light leakage prevention member that shields interference between the two or more light sources, a housing including a receiving space for receiving the light leakage prevention member, and a cover coupled to an upper end of the housing. The light leakage prevention member is a product composed of two types of colors or two types of molding materials in one mold, and the product is a heterogeneous material.

### CROSS-REFERENCE TO RELATED APPLICATION

This application claims the benefit under 35 USC § 119 (a) of Korean Patent Application No. 10-2024-0190028, filed on Dec. 18, 2024, in the Korean Intellectual Property Office, the entire disclosure(s) of which is hereby incorporated herein by reference in its entirety for all purposes.

### BACKGROUND

### 1. Field

The present disclosure relates to a light leakage prevention apparatus for a vehicle and a manufacturing method thereof.

### 2. Description of the Related Art

The description described in this part merely provides background information for the present disclosure, and does not constitute the conventional art.

The infotainment of a vehicle not only provides an entertainment function to a user, but also convenience in driving of the vehicle.

The infotainment of a vehicle includes a multimedia apparatus. For example, the multimedia apparatus may be configured in the form of a button used when playing an audio and a video. In order to ensure visibility during the day and night, the vehicle's infotainment irradiates light using a light source.

The infotainment of a vehicle according to the conventional art prevents light leakage of a light source by applying paint for preventing light leakage. However, the paint for preventing light leakage requires a spraying process, and there is a problem in that the manufacturing cost increases due to additional components needed therefor. In addition, in the spraying process, when the size of a masked component is small, a jig or the like cannot be applied. In addition, there is a problem that the paint for preventing light leakage invades a masking region, thereby lowering the quality and the yield.

### SUMMARY

A light leakage prevention apparatus for a vehicle according to an embodiment may reduce manufacturing cost by not using paint for preventing light leakage.

A light leakage prevention apparatus for a vehicle according to an embodiment may improve yield and quality by injecting light leakage prevention members of different materials using a double injection molding.

A light leakage prevention apparatus for a vehicle according to an embodiment may maintain brightness of a light source by using a microspace formed between a shielding member and a transmission member having different polarities.

The problems to be solved by the present disclosure are not limited to the above-mentioned problems, and other problems that are not mentioned will be clearly understood by those skilled in the art from the following description.

In a general aspect of the disclosure, a light leakage prevention apparatus for a vehicle, includes: a printed circuit board (PCB) comprising two or more light sources; a light leakage prevention member that shields interference between the two or more light sources; a housing including a space for accommodating the light leakage prevention member; and a cover coupled to an upper end of the housing, wherein the light leakage prevention member comprises a transmission member and a shielding member alternatingly disposed in a direction of light transmission of the two or more light source, and wherein the transmission member and the shielding member are manufactured by a double injection molding such that the transmission member and the shielding member have different color or comprise different materials from each other.

The transmission member may be disposed in front of one of the two or more light sources and configured to transmit and emit light of the light source that is disposed at a rear of at least one of the two or more light sources, and the shielding member may be coupled to the transmission member and configured to shield light from the light source disposed behind the transmission member and a remainder of the two or more light sources.

The transmission member and the shielding member may have different polarities such that the transmission member and the shielding member form one or more microspaces on surfaces bonded to each other during the double injection molding.

The transmission member may reflect the light of the light source disposed at the rear of the at least one of the two or more light sources to a reflection surface formed from the one or more microspaces.

The transmission member may include a polar molecule selected from the group consisting of polycarbonate (PC), polymethyl methacrylate (PMMA), and polyamide (PA).

The shielding member may include a nonpolar molecule selected from the group consisting of polyethylene (PE), and polyamide (PP).

The light leakage prevention member may be heat treated after the double injection molding.

In another general aspect of the disclosure, a method for manufacturing a light leakage prevention apparatus for a vehicle, includes: double injection molding a product to form a light leakage prevention member comprising a transmission member and a shielding member alternatingly disposed in a direction of light transmission of two or more light source in a printed circuit board (PCB); heat-treating the light leakage prevention member; coupling the light leakage prevention member into a receiving space of a housing; and coupling a cover to an upper end of the housing, wherein the transmission member and the shielding member have different color or comprise different materials from each other by the double injection molding.

The heat-treating of the light leakage prevention member may include separating the transmission member and the shielding member from each other by a microspace.

The coupling of the light leakage prevention member into the receiving space of the housing may include disposing the light leakage prevention member in front of the at least one of two or more light sources to shield optical interference between different light sources.

The transmission member may include a polar molecule selected from the group consisting of polycarbonate (PC), polymethyl methacrylate (PMMA), and polyamide (PA).

The shielding member may include a nonpolar molecule selected from the group consisting of polyethylene (PE) and polyamide (PP).

According to an embodiment, since a light leakage prevention apparatus for a vehicle does not use paint for preventing light leakage, there is an effect of reducing the manufacturing cost.

According to an embodiment, a light leakage prevention apparatus for a vehicle has an effect of improving yield and quality by injecting light leakage prevention members of different materials using a double injection molding.

According to an embodiment, a light leakage prevention apparatus for a vehicle has an effect of maintaining brightness of a light source by using a microspace formed between a shielding member and a transmission member having different polarities.

### BRIEF DESCRIPTION OF THE DRAWINGS

FIG. 1 is a diagram illustrating a configuration of a light leakage prevention apparatus for a vehicle according to an embodiment of the present disclosure.

FIG. 2 is an exploded perspective view of a light leakage prevention apparatus for a vehicle according to an embodiment of the present disclosure.

FIG. 3 is a cross-sectional view taken along line A-A in FIG. 1.

FIG. 4 is a diagram briefly illustrating a configuration of a light leakage prevention apparatus for a vehicle according to another embodiment of the present disclosure.

### DETAILED DESCRIPTION

Hereinafter, some embodiments of the present disclosure will be described in detail with reference to exemplary drawings. Note that when components in each drawing are denoted by reference numerals, the same components are denoted by the same numerals as much as possible even if they are denoted on different drawings. In addition, in describing the present disclosure, if it is determined that a specific description of a related known configuration or function may obscure the subject matter of the present disclosure, the detailed description thereof will be omitted.

In describing components of embodiments of the present disclosure, reference numerals such as first, second, i), ii), a), and b) may be used. These symbols are only used to distinguish the components from other components, and the nature, sequence, order, or the like of the components is not limited by the symbols. In the specification, when a part “includes” or “comprises” a component, unless there is an explicit description to the contrary, the part may further include other components rather than excluding the other components.

In describing the components of the present invention, the terms first, second, A, B, (a), (b) and the like may be used. These terms are only used to distinguish the components from other components, and the nature, sequence, order, or the like of the components is not limited by these terms.

Where a component is described as being “connected,” “coupled” or “connected” to another component, it will be understood that the component may be directly connected or connected to the component, but that between each component another component may be “connected,” “coupled” or “connected.”

Terms such as “unit” and “module” described in the specification mean a unit that processes at least one function or operation, and may be implemented by hardware, software, or a combination of hardware and software.

Unless otherwise specified, it should be understood that the description of one embodiment may be applied to other embodiments.

The description set forth below in connection with the attached drawings is intended to describe exemplary embodiments of the present disclosure and is not intended to represent the only embodiments in which the present disclosure may be practiced.

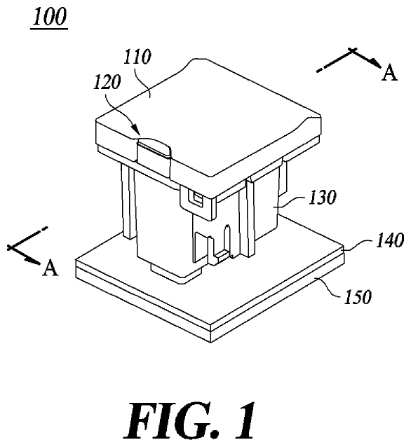

FIG. 1 is a diagram illustrating a configuration of a light leakage prevention apparatus for a vehicle according to an embodiment of the present disclosure.

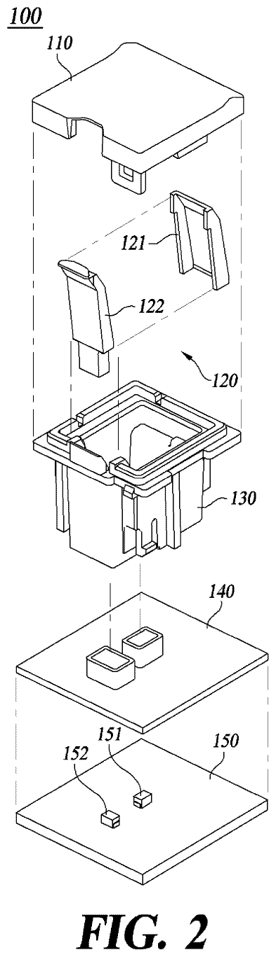

FIG. 2 is an exploded perspective view of a light leakage prevention apparatus for a vehicle according to an embodiment of the present disclosure.

Referring to FIGS. 1 and 2, a light leakage prevention apparatus for a vehicle 100 may be applied to a button inside the vehicle applied to an infotainment.

The light leakage prevention apparatus for a vehicle 100 according to an embodiment of the present disclosure includes a cover unit 110, a light leakage prevention member 120, a housing 130, a rubber pad 140, a printed circuit board (PCB) 150, and some or all of a plurality of light sources 151 and 152.

Light emitted from a first light source 151 among the plurality of light sources 151 and 152 is directly transmitted through the cover unit 110. An image indicating an operation state of the button may be engraved or painted on an upper surface of the cover unit 110.

The cover unit 110 is coupled to the housing 130 to be described later. The cover unit 110 may be snap-fit coupled to the housing 130.

The light leakage prevention member 120 is coupled to any one of receiving spaces of the housing 130. The light leakage prevention member 120 may shield optical interference between the two light sources 151 and 152.

The light leakage prevention member 120 may be manufactured based on a dual injection molding. Here, the double injection molding refers to a process of producing a product composed of two types of colors or two types of molding materials in one mold. The light leakage prevention member 120 according to an embodiment of the present disclosure may be manufactured by using molding materials having different polarities.

The light leakage prevention member 120 includes a shielding member 121 and a transmission member 122.

The shapes of the shielding member 121 and the transmission member 122 illustrated in FIG. 2 are not limited thereto. The shapes of the shielding member 121 and the transmission member 122 according to another embodiment of the present disclosure may be a curved structure or a banding structure.

The light leakage prevention member 120 may be disposed in a local area where masking painting is not possible.

The transmission member 122 may be disposed in front of any one of the plurality of light sources 151 and 152 formed on the PCB 150. The transmission member 122 is formed based on a transparent material so as to emit light by using light of a light source disposed at the rear.

A partial region of the transmission member 122 may be exposed to the outside direction of the cover unit 110. For example, the transmission member 122 may transmit visual information to the user by using light emitted from the second light source 152.

The transmission member 122 according to an embodiment of the present disclosure has a polar molecular structure. The transmission member 122 may be manufactured based on, for example, one of polycarbonate (PC), polymethyl methacrylate (PMMA), and polyamide (PA).

On the other hand, the shielding member 121 has a nonpolar molecular structure. The shielding member 121 may be manufactured based on, for example, one of polyethylene (PE) and polypropylene (PP).

When the light leakage prevention member 120 is manufactured based on the double injection molding, the transmission member 122 and the shielding member 121 are separated from each other. The fact that the transmission member 122 and the shielding member 121 are separated from each other means that a microspace is formed between the transmission member 122 and the shielding members 121. Although the transmission member 122 and the shielding member 121 are manufactured based on a double injection molding, they may be separated due to different polarities.

The molecular structure between the transmission member 122 and the shielding member 121 may be separated by a van der Waals force. Here, the van der Waals force means an attractive force or repulsion between molecules or between parts in one molecule, and not a covalent bond or an electrical interaction of ions. Specifically, in the case of a nonpolar molecule, a dipole molecule is formed due to the motion of electrons, and a molecule next to the dipole molecule also undergoes temporary polarization to generate an induced dipole. This instantaneous attractive force between the dipole molecule and the induced dipole is called the van der Waals force.

Van der Waals forces include the Keesom force, the permanent induced dipole (Debye) force and the London dispersion force.

The Keesom force refers to the bond between permanent dipoles, which is the bond between polar and polar. The permanent induced dipole force means a bond between a permanent dipole and an induced dipole that is a bond between polar and nonpolar. The London dispersion force refers to the coupling between the induced dipole and the induced dipole, which is the coupling between the nonpolar and the nonpolar. The binding force is strong in the order of Keesom force, permanent induced dipole force and London dispersion force. Compared with polar and polar materials, polar and nonpolar materials have relatively weak bonding strength. Therefore, in the light leakage prevention member 120 according to an embodiment of the present disclosure, the shielding member 121 and the transmission member 122 may be separated from each other based on a permanent induced dipole force of polar and nonpolar materials.

In the case where a microspace is formed between the transmission member 122 and the shielding member 121, light transmitted through the transmission member 122 may be reflected without being absorbed when irradiated to the side of the shielding member 122. Therefore, the light leakage prevention member 120 according to an embodiment of the present disclosure may be disposed in an area requiring a high brightness specification.

The housing 130 is disposed on an upper end of the rubber pad 140. The housing 130 is coupled to the rubber pad 140 in accordance with a position of a hole (not shown) formed on the rubber pad 140. The hole formed on the rubber pad 140 may be formed based on the positions of the first light source 151 and the second light source 152.

The housing 130 includes a receiving space for receiving the light leakage prevention member 120. The receiving space includes a groove to which the light leakage prevention member 120 is coupled. The light leakage prevention member 120 may be restrained from moving in all directions by being coupled to the groove.

The PCB 150 includes the first light source 151 and the second light source 152. The first light source 151 and the second light source 152 may be light emitting diodes (LEDs). The first light source 151 and the second light source 152 may be disposed on either top surface of the PCB 150.

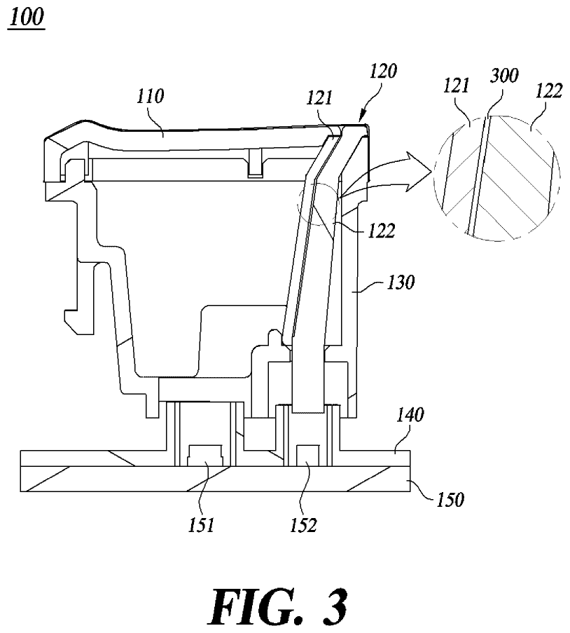

FIG. 3 is a cross-sectional view taken along line A-A in FIG. 1.

Referring to FIG. 3, the light leakage prevention member 120 may be disposed in front of the second light source 152. When the first light source 151 emits light, the light emitted from the first light source 151 may be reflected by the inner wall of the housing 130 and the shielding member 121 and may be emitted to the side of the cover unit 110. Here, the light emitted from the first light source 151 is not transmitted to the transmission member 122.

The light emitted from the second light source 152 may be transmitted through the transmission member 122 and emitted to the side of the cover unit 110. Due to the microspace between the shielding member 121 and the transmission member 122, the brightness of the light emitted from the second light source 152 may be maintained when the light is transmitted through the transmission member 122.

The light leakage prevention member 120 may shield interference between the first light source 151 and the second light source 152.

In a light leakage prevention member according to the conventional art, a coupling surface is formed between the shielding member and the transmission member due to the double injection molding. The coupling surface between the black-colored shielding member and the transparent material transmission member has a black color based on the color of the shielding member. Therefore, the light transmitted through the transmission member may be partially absorbed by the coupling surface having a black color. Therefore, the light leakage prevention member according to the conventional art is not suitable for the high brightness specification, while in the light leakage prevention member 120 according to an embodiment of the present disclosure, the shielding member 121 and the transmission member 122 are separated so that the transmission member 122 does not have a black color unlike the color of the shielding member 122. Therefore, when the light emitted from the second light source 152 is transmitted through the transmission member 122, the light is reflected by a microspace 300, and the brightness may be maintained. Therefore, the light leakage prevention member 120 according to an embodiment of the present disclosure may be disposed in a region where a high brightness specification is required.

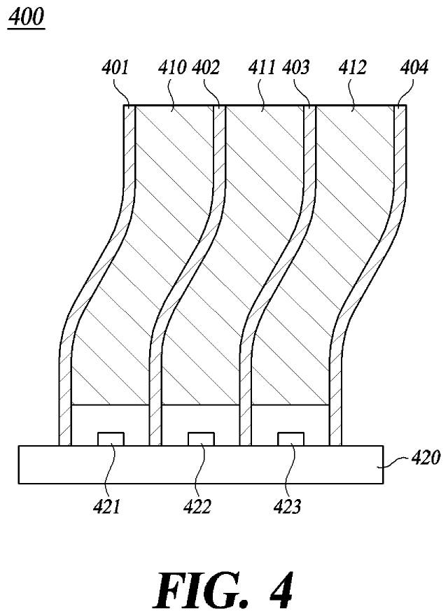

FIG. 4 is a diagram briefly illustrating a configuration of a light leakage prevention apparatus for a vehicle according to another embodiment of the present disclosure.

Referring to FIG. 4, a light leakage prevention apparatus for a vehicle 400 according to another embodiment of the present disclosure may include a plurality of shielding members 401, 402, 403, and 404 and a plurality of transmission members 410, 411, and 412. The plurality of shielding members 401, 402, 403, and 404 and the plurality of transmission members 410, 411, and 412 may be continuously injected and manufactured.

The plurality of shielding members 401, 402, 403, and 404 and the plurality of transmission members 410, 411, and 412 may have a curved structure or a banding structure. The structures of the plurality of shielding members 401, 402, 403, and 404 and the plurality of transmission members 410, 411, and 412 are not limited thereto. The plurality of shielding members 401, 402, 403, and 404 and the plurality of transmission members 410, 411, and 412 may be disposed in a curved region to shield interference between the plurality of light sources.

The plurality of shielding members 401, 402, 403, and 404 and the plurality of transmission members 410, 411, and 412 may be directly coupled onto a PCB 420. Although not shown in FIG. 4, the plurality of shielding members 401, 402, 403, and 404 and the plurality of transmission members 410, 411, and 412 may be restrained from moving by an additional structure or the like in the vicinity of the disposed region.

A light leakage prevention apparatus for a vehicle 400 according to another embodiment of the present disclosure may shield interference between a plurality of light sources 421, 422, and 423. The light leakage prevention apparatus for a vehicle 400 may shield optical interference between the first light source 421, the second light source 422, and the third light source 423.

The light leakage prevention apparatus for a vehicle 400 according to another embodiment of the present disclosure includes a shielding member 401, a second shielding member 402, a third shielding member 403, a fourth shielding member 404, a first transmission member 410, a second transmission member 411, and a third transmission member 412.

A PCB 420 according to another embodiment of the present disclosure includes some or all of the first light source 421, the second light source 422, and the third light source 423. This is but one embodiment, and the number of light sources included on the PCB 420 may be greater.

The first transmission member 410 has a polar molecular structure, and the first shielding member 401 and the second shielding member 402 have a nonpolar molecular structure. Therefore, the first transmission member 410 may form microspaces separated from the first shielding member 401 and the second shielding member 402, respectively. The light emitted from the first light source 421 may be transmitted through the first transmission member 410 and emitted in an outside direction. When the light of the first light source 421 is irradiated to the outside, the path of the light is reflected to the microspace respectively formed between the first transmission member 410 and the first shielding member 401 and the second shielding member 402. Here, the light emitted from the first light source 421 is reflected without being absorbed into the microspace. Therefore, the brightness of light may be uniformly maintained.

The second transmission member 411 has a polar molecular structure, and the third shielding member 403 has a nonpolar molecular structure. Therefore, the second transmission member 411 may form microspaces separated from the second shielding member 402 and the third shielding member 403, respectively. The light emitted from the second light source 422 may be transmitted through the second transmission member 411 and emitted in an outside direction. When the light of the second light source 422 is irradiated to the outside, the path of the light is reflected to the microspaces respectively formed between the second transmission member 411 and the second shielding member 402 and the third shielding member 403. Here, the light emitted from the second light source 422 is reflected without being absorbed into the microspace. Therefore, the brightness of light may be uniformly maintained.

The third transmission member 412 has a polar molecular structure, and the fourth shielding member 404 has a nonpolar molecular structure. Therefore, the third transmission member 412 may form microspaces separated from the third shielding member 403 and the fourth shielding member 404, respectively. The light emitted from the third light source 423 may be transmitted through the third transmission member 412 and emitted in an outside direction. When the light of the third light source 423 is irradiated to the outside, the path of the light is reflected to the microspace respectively formed between the third transmission member 412 and the third shielding member 403 and the fourth shielding member 404. Here, the light emitted from the third light source 423 is reflected without being absorbed into the microspace. Therefore, the brightness of light may be uniformly maintained.

The foregoing descriptions are merely illustrative of the technical concept of the present embodiment, and various modifications and variations may be made by those skilled in the art without departing from the essential characteristics of the present embodiment. Therefore, the present embodiments are not intended to limit the technical concept of the present embodiments, but are intended to be illustrative, and the scope of the technical concept of the present embodiment is not limited by these embodiments. The protection scope of the present embodiment is to be construed according to the following claims, and all technical concepts within the scope equivalent thereto are construed as being included in the scope of rights of the present embodiment.

What is claimed is:

1. A light leakage prevention apparatus for a vehicle, the apparatus comprising:
a printed circuit board (PCB) comprising two or more light sources;
a light leakage prevention member that shields interference between the two or more light sources;
a housing including a space for accommodating the light leakage prevention member; and
a cover coupled to an upper end of the housing,
wherein the light leakage prevention member comprises a transmission member and a shielding member alternatingly disposed in a direction of light transmission of the two or more light source, and
wherein the transmission member and the shielding member are manufactured by a double injection molding such that the transmission member and the shielding member have different color or comprise different materials from each other.

2. The apparatus of claim 1,
wherein the transmission member is disposed in front of one of the two or more light sources and configured to transmit and emit light of the light source that is disposed at a rear of at least one of the two or more light sources, and
wherein the shielding member is coupled to the transmission member and configured to shield light from the light source disposed behind the transmission member and a remainder of the two or more light sources.

3. The apparatus of claim 2, wherein the transmission member and the shielding member have different polarities such that the transmission member and the shielding member form one or more microspaces on surfaces bonded to each other during the double injection molding.

4. The apparatus of claim 3, wherein the transmission member reflects the light of the light source disposed at the rear of the at least one of the two or more light sources to a reflection surface formed from the one or more microspaces.

5. The apparatus of claim 2, wherein the transmission member comprises a polar molecule selected from the group consisting of polycarbonate (PC), polymethyl methacrylate (PMMA), and polyamide (PA).

6. The apparatus of claim 2, wherein the shielding member comprises a nonpolar molecule selected from the group consisting of polyethylene (PE), and polyamide (PP).

7. The apparatus of claim 1, wherein the light leakage prevention member is heat treated after the double injection molding.

8. A method for manufacturing a light leakage prevention apparatus for a vehicle, the method comprising:
double injection molding a product to form a light leakage prevention member comprising a transmission member and a shielding member alternatingly disposed in a direction of light transmission of two or more light source in a printed circuit board (PCB);
heat-treating the light leakage prevention member;
coupling the light leakage prevention member into a receiving space of a housing; and
coupling a cover to an upper end of the housing,
wherein the transmission member and the shielding member have different color or comprise different materials from each other by the double injection molding.

9. The method of claim 8, wherein the heat-treating of the light leakage prevention member comprises separating the transmission member and the shielding member from each other by a microspace.

10. The method of claim 8, wherein the coupling of the light leakage prevention member into the receiving space of the housing comprises disposing the light leakage prevention member in front of the at least one of two or more light sources to shield optical interference between different light sources.

11. The method of claim 9, wherein the transmission member comprises a polar molecule selected from the group consisting of polycarbonate (PC), polymethyl methacrylate (PMMA), and polyamide (PA).

12. The method of claim 9, wherein the shielding member comprises a nonpolar molecule selected from the group consisting of polyethylene (PE) and polyamide (PP).
